(19) United States
(12) Patent Application Publication
(10) Pub. No.: US 2013/0182651 A1
(43) Pub. Date: Jul. 18, 2013

(54) Virtual Private Network Client Internet Protocol Conflict Detection

(71) Applicants: Amol Dhananjay Kelkar, Bangalore (IN); Amerneni Varaprasad Rao, Bangalore (IN)

(72) Inventors: Amol Dhananjay Kelkar, Bangalore (IN); Amerneni Varaprasad Rao, Bangalore (IN)

(21) Appl. No.: 13/350,584

(22) Filed: Jan. 13, 2012

(51) Int. Cl. H04W 72/04

(52) U.S. Cl. 370/329

(57) ABSTRACT

The present disclosure discloses a network device and/or method for virtual private network client Internet Protocol (IP) address conflict detection in the wireless network. The network device receives, from a VPN client, a message that includes a first private IP address corresponding to a VPN client, and re-allocates a second private IP address corresponding to the same VPN client. The second private IP address resolves an IP address conflict between a tentative private IP address allocated for the VPN client by the VPN server within the wireless network and the first private IP address allocated for the VPN client by an ISP server external to the wireless network. The network device also transmits the first private IP address and the second private IP address in a single message, such as a single IP data packet, to the VPN client.

### BACKGROUND OF THE INVENTION

The present disclosure relates to virtual private networks. In particular, the present disclosure relates to detection of virtual private network client Internet Protocol (IP) address conflicts.

Wireless digital networks, such as networks operating under Electrical and Electronics Engineers (IEEE) 802.11 standards, are spreading in their popularity and availability. With such popularity, however, come problems of virtual private network (“VPN”) client address management.

A virtual private network (“VPN”) generally refers to a private network that uses primarily public telecommunication infrastructure, such as the Internet, to provide remote users access to a central corporate network. VPNs typically require remote users of the network to be authenticated, and often secure data with encryption technologies to prevent disclosure of private information to unauthorized parties. VPNs may serve any network functionality that is found on any network. A VPN user typically experiences the central corporate network in a manner that is identical to being connected directly to the central corporate network.

Split tunneling generally refers to the networking concept that a VPN client may access a public network (e.g., the Internet) and a local area network (e.g. the corporate intranet) at the same time, using the same physical network connection. For example, a user may connect to a central corporate network through a remote access VPN software client using a hotel network. With split tunneling enabled, the user is able to connect to file servers, database servers, mail servers and other servers on the central corporate network through the VPN connection. Meanwhile, when the user connects to Internet resources, such as, Internet websites, File Transfer Protocol (FTP) sites, etc., the connection request is transmitted directly through the gateway provided by the hotel network.

To enable VPN connection with split tunneling, a VPN client that remotely accesses a corporate network will need to be allocated IP addresses that both are reachable by hosts on the corporate intranet and can be processed properly by Internet routers. To emulate a point-to-point link, data is encapsulated or wrapped with a header that provides routing information allowing it to traverse the shared or public network (e.g., Internet) to reach its endpoint. To emulate a private link, the data being sent is encrypted for confidentiality so that packets intercepted on the public network are indecipherable without the encryption keys. Moreover, the encrypted data includes intranet address information to provide corporate intranet access. Accordingly, an inner IP address and an outer IP address are typically combined in a data packet according to most VPN client addressing mechanisms.

Specifically, an inner IP address may be assigned by a VPN server in the central corporate network. For example, the VPN server may be configured to set up clients of the corporate network with IP addresses such as “192.168.2.x.” Nevertheless, it is possible that an overlapping outer IP address is also assigned by an ISP server to a VPN client with “192.169.2.3.” As a result of the private IP address conflict, the VPN client will lose both the Intranet and the Internet connectivity. Conventionally, in order to solve such connectivity issues, a network administrator would have to disable split tunneling and establish a full secured tunnel between the client and the corporate network. Thus, the client would likely lose the Internet connectivity. Otherwise, the VPN server would have to be configured to route Internet traffic from clients through the corporate network, which might expose the corporate network to security weaknesses.

### BRIEF DESCRIPTION OF THE DRAWINGS

The present disclosure may be best understood by referring to the following description and accompanying drawings that are used to illustrate embodiments of the present disclosure.

FIGS. 1A-1B each shows a respective exemplary wireless network environment according to embodiments of the present disclosure.

FIG. 2A is a block diagram illustrating an exemplary data packet format according to embodiments of the present disclosure.

FIG. 2B is a block diagram comparing IP address allocations according to embodiments of the present disclosure.

FIG. 3 is a sequence diagram illustrating an exemplary communication exchanges in the network according to embodiments of the present disclosure.

FIG. 4 is a flowchart illustrating a process for VPN client IP address conflict detection according to embodiments of the present disclosure.

FIG. 5 is a block diagram illustrating a system for VPN client IP address conflict detection according to embodiments of the present disclosure.

### DETAILED DESCRIPTION

In the following description, several specific details are presented to provide a thorough understanding. While the context of the disclosure is directed to VPN client addressing mechanisms in wireless networks, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to virtual private network client IP addressing mechanisms. Specifically, embodiments of the present disclosure provide detection and avoidance of VPN client IP address conflicts prior to assigning a private IP address to a VPN client by a VPN server. The VPN client may be a wired and/or wireless client. The comprehensive solution described herein enables split tunneling and preserves both Internet and intranet connectivity for VPN clients even when both an ISP server and the VPN server assign IP addresses to their clients in the same private IP address space.

With the solution provided herein, the disclosed network device receives, from a VPN client, a message that includes a first private IP address corresponding to a VPN client, and re-allocates a second private IP address corresponding to the same VPN client. Specifically, the second private IP address resolves an IP address conflict between a tentatively allocated private IP address corresponding to the VPN client and the first private IP address.

In some embodiments, the network device may further allocate the tentative private IP address; extract the first private IP address from the received message; and determine whether the tentative private IP address is in conflict with the first private IP address. In some embodiments, the network device re-allocates the second private IP address in response to determining that the tentative private IP address is in conflict with the first private IP address. Note that the second private IP address is different from both the first private IP address and the tentatively private IP address.

In some embodiments, the network device also transmits the first private IP address and the second private IP address in a single message, such as a single IP data packet, to the VPN client. In particular, the second private IP address allocated by the VPN server may be encrypted and encapsulated as an inner IP address. Moreover, the first private IP address allocated by the ISP server external to the wireless network may be unencrypted and included in the single IP data packet as an outer IP address.

Note that present disclosure can be applicable to both user devices, such as a mobile phone, a laptop, a desktop computer, etc., and VPN tunnel based network devices, such as access points, network controllers, switches, etc.

### Computing Environment

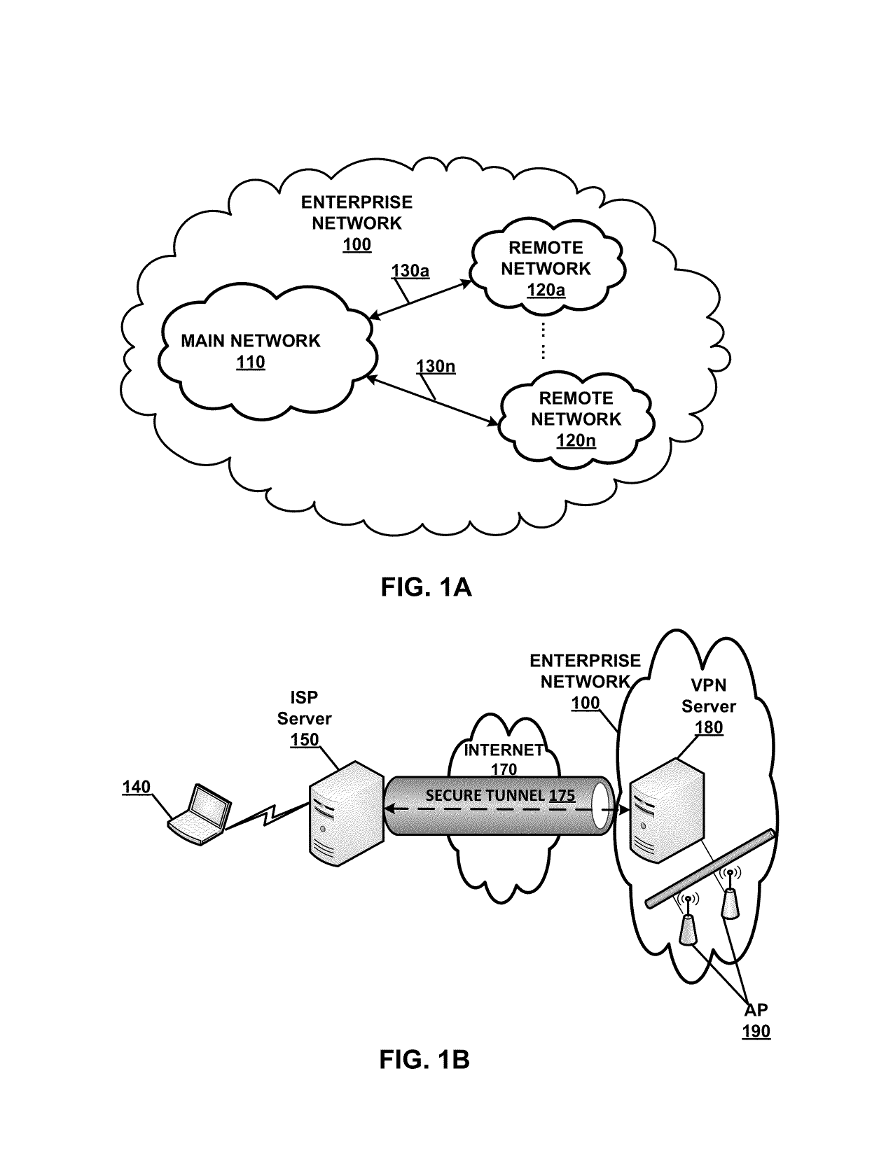

FIGS. 1A-1B show an exemplary wireless digital network environment according to embodiments of the present disclosure. FIG. 1 A shows an enterprise network 100, which includes main network 110 and a plurality of remote networks 120a-120n. Main network 110 may operate on a private network including one or more local area networks.

The local area networks may be adapted to allow wireless access, thereby operating as a wireless local area network (WLAN). One or more remote networks 120a-120n are remotely located from main network 110 and are in communication via interconnect 130a-130n. According to one embodiment of the invention, communications are established between main network 110 and remote networks 120a-120n via interconnects 130a-130n, respectively.

FIG. 1B illustrates a detailed exemplary embodiment of network communication between enterprise network 100 and client 140. According to this embodiment, enterprise network 100 features a WLAN that comprises a VPN server 180 in communication with one or more access points 190 via wired and/or wireless information-carrying medium, which provides either a direct or indirect communication path between access points 190 to VPN server 160. Moreover, one or more wireless stations (not shown) in main network may be in communication with access points 190 over wireless interconnects. Enterprise network 100 may additionally include one or more of a Dynamic Host Configuration Protocol (DHCP) server, a Doman Name System (DNS) server, a file server, a print server, a messaging server, an application server, a database server, etc. Note that access points 190 may be communicating with wireless stations in enterprise network 100 over multiple communication channels via multiple radios. Moreover, client 140 may be coupled with a remote Internet Service Provider (ISP) server 150, which is coupled with Internet 170 and with enterprise network 100 through Internet 170. In particular, secure tunnel 175 may be established between client 140 and enterprise network 100 for corporate intranet traffic. In some embodiments, secure tunnel 175 may be an end-to-end secure operating scheme between two hosts, two network gateways, or a host and a network gateway. Establishing secure tunnel 175 may involve authentication, encryption, cryptographic key exchange, etc. For example, an Internet Protocol Security (IPsec) may be established as secure tunnel 175 for securing IP communication sessions between client 140 and enterprise network 100. However, other security protocols in other network layers may be utilized without departing from the spirit of the present disclosure.

During operation, client 140 requests for connection with ISP server 150. In response, ISP server 150 assigns an IP address to client 140. The IP address may be a public IP address, which is a globally routable unicast IP address, or a private IP address, which is within a reserved address range for private networks and link-local addressing. Moreover, the IP address assigned to client 140 may be a 32-bit address in accordance with Internet Protocol version 4 (IPv4).

Next, client 140 requests to establish secure tunnel 175 with enterprise network 100. In response, VPN server 180 may assign an IP address to client 140 to facilitate client 140 connect to other hosts within enterprise network 100. Specifically, VPN server 180 may allocate a tentative IP address to client 140. The tentative IP address may be either a public IP address or a private IP address depending on VPN server configuration and/or enterprise policies. In addition, VPN server 180 may inspect the IP packet received from client 140, extract the IP address assigned to client 140 by ISP server 150, and determine whether the extracted IP address is a private IP address that creates an IP address conflict with the tentative private IP address allocated to client 140. If so, VPN server 180 will resolve the IP address conflict, and assign a different private IP address to client 140 that creates no conflict with the private IP address assigned to client 140 by ISP server 150. Also, VPN server 180 may transmit back to client 140 both private IP addresses assigned to client 140 by ISP server 150 and by VPN server 180 in a single IP packet.

Data Packet with IP Address Allocations

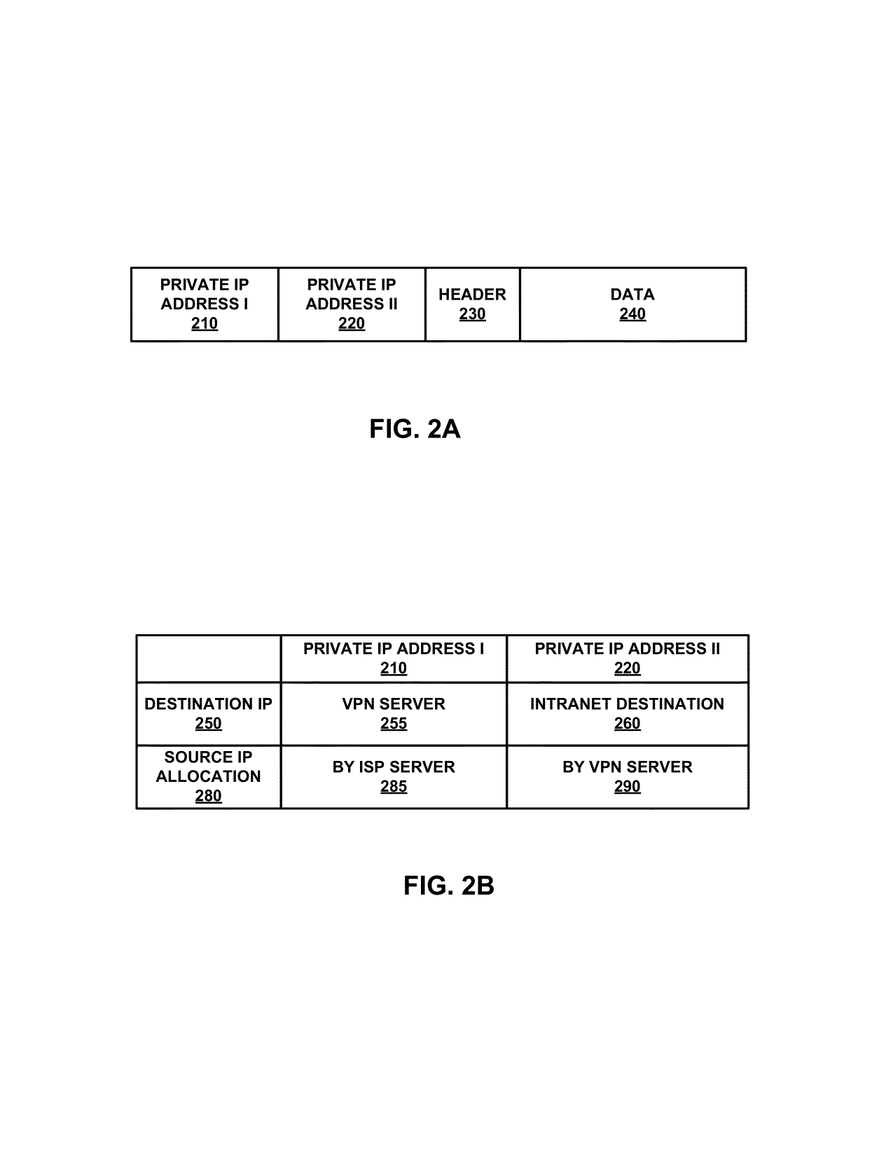

FIG. 2A shows a block diagram illustrating an exemplary data packet format. According to embodiments of the present disclosure, an exemplary IP packet transmitted between the client and the VPN server includes, inter alia, private IP address I 210, private IP address II 220, header 230, and data 240. As shown, each VPN client connecting remotely through an ISP server will be assigned two IP addresses, both of which are private in the illustrated example. Each of private IP address I 210 and private IP address II 220 includes a source IP address and a destination IP address to indicate the source node and the destination node of the IP packet respectively. In one embodiment, private IP address II 220, header 230, and data 240 are encrypted and protected by a secure tunnel established between a remote client and the enterprise network.

FIG. 2B shows a block diagram comparing IP address allocations. According to this illustrated embodiment, the inner IP address, private IP address II 220, may be allocated by the VPN server, and must be reachable by hosts on the enterprise network. That is, the VPN server includes appropriate entries in its routing table to reach other hosts on the enterprise network. Likewise, hosts on the enterprise network can reach the remote client via private IP address II 220, which requires that the routers of the enterprise network intranet have appropriate entries for the remote VPN client.

When the remote VPN client sends an IP packet to another host on enterprise network, the IP packet, which comprises the tunneled data 240, will be transmitted through a previously established secure tunnel, such as an IPsec tunnel, from private IP address II 220 allocated 280 to the remote client by VPN server 290 to another private IP address mapping to intranet destination 260 corresponding to the other host on the enterprise network. On the other hand, the outer IP address, private IP address I 210, will be used to route the IP packet through Internet. Private address I 210 includes a source IP address 280 which is the address allocated by the ISP server 285, and a destination IP address 250 which maps to the public IP address of the VPN server 255 in the enterprise network. Because the routers on the Internet can only process the outer IP address in the data packet, the Internet routers will forward the tunneled data 240, which is encrypted and encapsulated, along with header 230 and private IP address II in the same IP data packet, to the VPN server's public IP address.

### IP Addressing Mechanisms

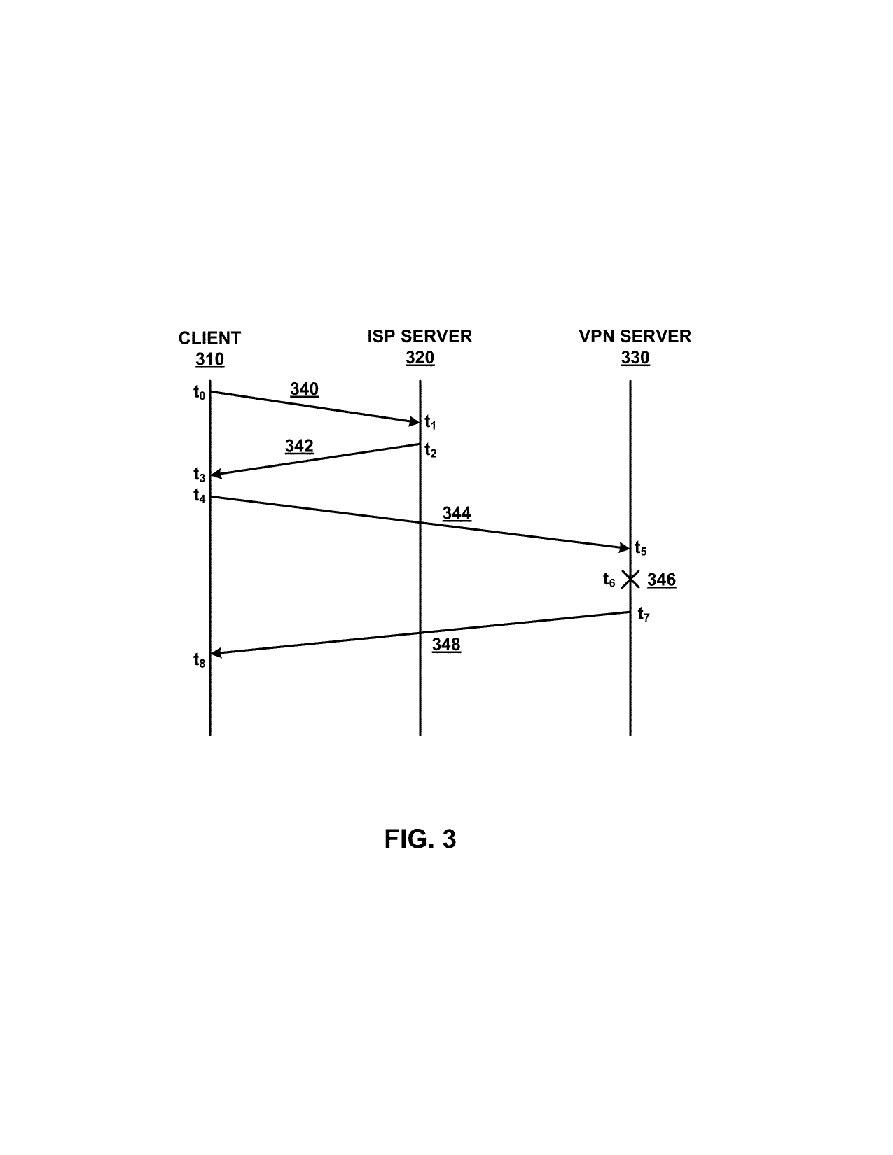

FIG. 3 is a sequence diagram illustrating an exemplary communication exchanges in the enterprise network. According to this embodiment, the network environment includes, but is not limited to, client 310, ISP server, and VPN server 330. In a set of exemplary communication exchanges according to the embodiments illustrated in FIG. 3, at time point t₀, client 310 initiates IP request packet 340 to ISP server 320. ISP server 320 receives the request at time point t₁, and sends IP response packet 342 back to client 310 at time point t₂. In IP response packet 342, ISP server 320 can include an IP address allocated to client 310 by ISP server 320. The IP address allocated by ISP server 320 may be a public IP address or a private IP address. Subsequently, client 310 will use this IP address in all communications with ISP server 320 to identify client 310 itself, and vice versa. Note that, if ISP server 320 is configured to assign a private IP address to client 310. Upon receiving the

IP data packet from client 310, ISP server 320 can translate the private IP address to the public IP address of ISP server 320, so that ISP server 320 can receive properly response packets from Internet and route them back to client 310. In some embodiments, the private IP address assigned to client 310 is selected from one or more IP address sub networks that are reserved for private networks and/or link-local addressing, e.g., 192.168.x.x, 10.x.x.x, and 172.16.x.x-172.31.x.x in an IPv4 network.

At time point t₄, assuming client 310 needs to communicate with the enterprise intra network. Client 310 will then send an IP data packet 344 through ISP server 320 across Internet to VPN server 330 in the enterprise network. As illustrated in FIG. 3, VPN server 330 receives data packet 344 from client 310 at time point t₅. Thereafter, rather than assigning and directly returning a private IP address for use within the enterprise intra network for client 310, VPN server performs a series operations 346 at time point t₆. First, VPN server may assign a tentative IP address to client 310. The tentative IP address may be either a public IP address or a private IP address depending on VPN server configuration and/or enterprise policies. Second, VPN server 180 may further inspect IP data packet 344 received from client 310, extract the IP address assigned to client 310 by ISP server 320, and determine whether the extracted IP address is a private IP address that creates an IP address conflict with the tentative IP address allocated to client 310 by VPN server 330. If so, VPN server 330 will resolve the IP address conflict, and assign a different private IP address to client 310 that creates no conflict with the private IP address assigned to client 310 by ISP server 320.

Finally, at time point t₇, VPN server 330 transmits back to client 310 a response IP data packet 348, including both private IP addresses assigned to client 310 by ISP server 320 and by VPN server 330.

### VPN Client IP Address Conflict Detection Process

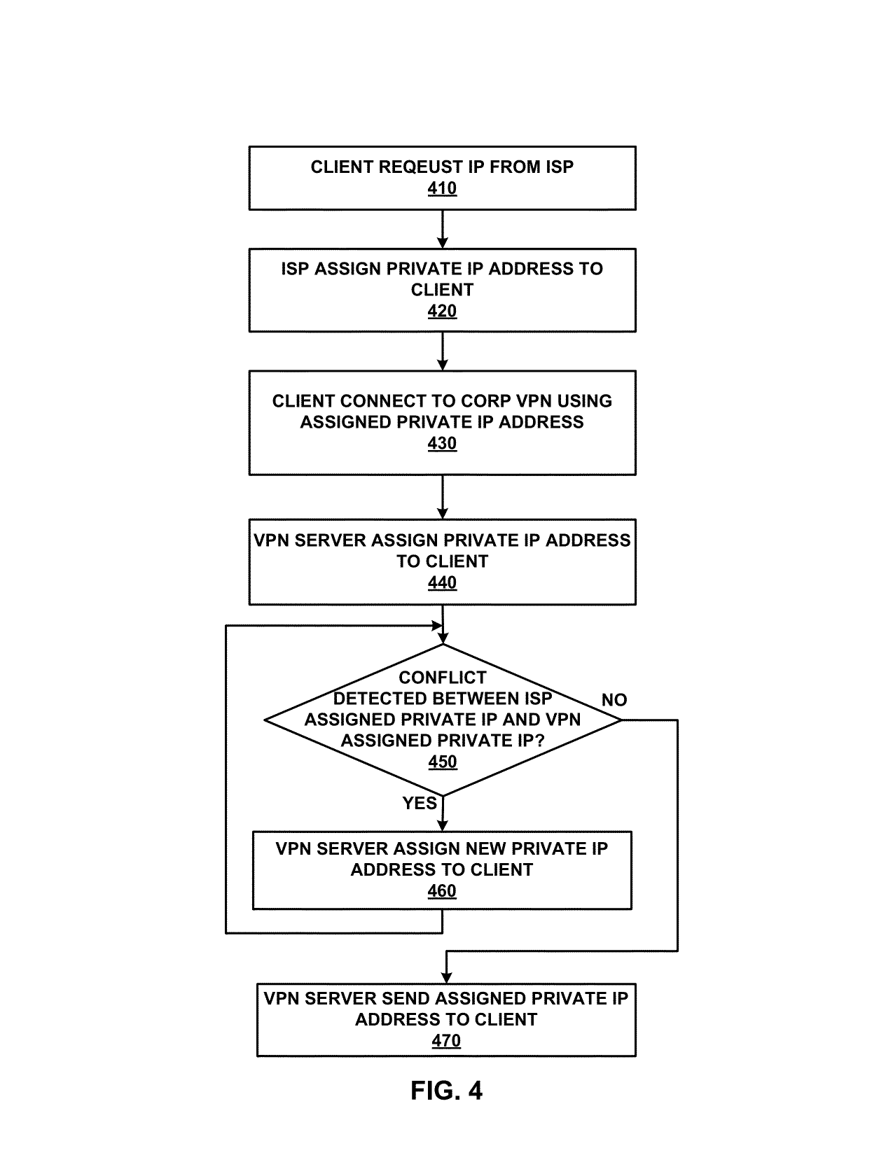

FIG. 4 is a flowchart illustrating the process of VPN client IP address conflict detection. During operation, an ISP server receives a request from a client, which requests an IP address from the ISP server (operation 410). In response, the ISP server assigns an IP address, for example, a private IP address, to the client (operation 420). Subsequently, the client connects to the corporate VPN using the IP address allocated by the ISP server (operation 430). When a VPN server in the corporate network receives the connection request from the client, the VPN server also assigns an IP address (assuming also a private IP address in this example) to the client for routing intranet traffic to and from the client within the corporate network (operation 440).

Next, the VPN server determines whether an IP address conflict is detected between the private IP address assigned to the client by the ISP server and the private IP address assigned to the client by the VPN server (operation 450). In particular, the VPN server can inspect the IP data packet received from the client, and extract the IP address assigned to the client by the ISP server, and determine whether the extracted IP address is a private IP address that creates an IP address conflict with the IP address allocated to the client by the VPN server. If so, the VPN server will resolve the IP address conflict by assigning a new and different private IP address to the client that creates no conflict with the private IP address assigned to the client by the ISP server (operation 460). If the VPN server determines that there is no IP address conflict between the two private IP addresses allocated to the client, the VPN server will send the assigned private IP address to the client (operation 470). The client will use the private IP address assigned by the VPN server as inner source IP address and the private IP address assigned by the ISP server as outer source IP address in the same IP packet during future communication exchanges with the corporate network.

### VPN Client IP Address Conflict Detection System

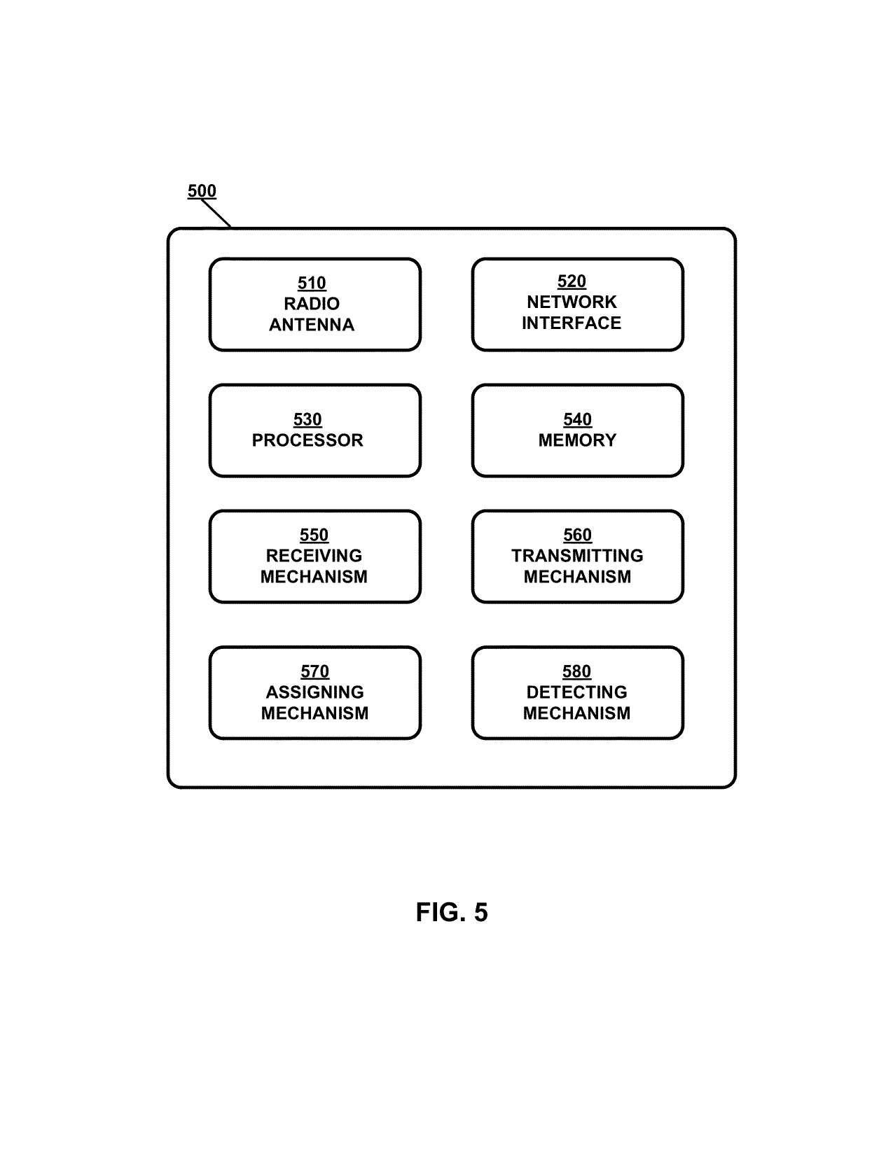

FIG. 5 is a block diagram illustrating a system for VPN client IP address conflict detection according to embodiments of the present disclosure.

Operating as a node in a wireless digital network, network device 500 includes at least one or more radio antennas 510 capable of either transmitting or receiving radio signals or both, a network interface 520 capable of communicating to a wired or wireless network, a processor 530 capable of processing computing instructions, and a memory 540 capable of storing instructions and data. Moreover, network device 600 further includes a receiving mechanism 550, a transmitting mechanism 560, an assigning mechanism 570, and a detecting mechanism 580, all of which are coupled to processor 530 and memory 540 in network device 500. Network device 500 may be used as a client system, or a server system, or may serve both as a client and a server in a distributed or a cloud computing environment.

Radio antenna 510 may be any combination of known or conventional electrical components for receipt of signaling, including but not limited to, transistors, capacitors, resistors, multiplexers, wiring, registers, diodes or any other electrical components known or later become known.

Network interface 520 can be any communication interface, which includes but is not limited to, a modem, token ring interface, Ethernet interface, wireless IEEE 802.11 interface, cellular wireless interface, satellite transmission interface, or any other interface for coupling network devices.

Processor 530 can include one or more microprocessors and/or network processors. Memory 540 can include storage components, such as, Dynamic Random Access Memory (DRAM), Static Random Access Memory (SRAM), etc. In some embodiments, memory 540 stores intranet routing information for an enterprise network, for example, in a routing table. An exemplary routing table may include one or more of the following columns: The routing table consists of at least three information fields: a network identifier, a cost or metric associated with the path through which the data packet is to be transmitted, a next-hop information indicating the address of the next station to which the data packet is to be transmitted on its way to the final destination of the data packet, a quality of service associated with the route, information regarding filtering criteria and/or access lists associated with the route, network interface indicator, etc. Routes specified in the routing table may be added manually as static routes by a network administrator. Alternatively, entries in the routing table may be generated dynamically on the fly as a result of network topology discovery. Note that embodiments of the present disclosure eliminates the need to statically configure routes for packets between the VPN client and the enterprise network in order to preserve Internet and/or intranet connectivity for the VPN client in case of private IP address conflict described herein.

Receiving mechanism 550 receives one or more network messages via network interface 520 or radio antenna 510 from a VPN client. The received network messages may include, but are not limited to, requests and/or responses, beacon frames, management frames, control path frames, and so on, as described in the present disclosure. Each message may comprise one or more data packets, for example, in the form of IP packets. For example, an IP data packet may include, inter alia, a first private IP address allocated by an ISP server, a second private IP address allocated by a VPN server, a header, and data. In some embodiments, the private IP address allocated by the VPN server must be included in an entry in the routing table stored in memory 540 of network device 500, and be reachable by hosts on the enterprise network that is coupled with network device 500.

Transmitting mechanism 560 transmits both the first private IP address allocated by the ISP server and the second private IP address allocated by the VPN server to the VPN client in a single message.

Assigning mechanism 570, according to embodiments of the present disclosure, re-allocates a second private IP address corresponding to the VPN client. Also, the second private IP address resolves an IP address conflict between (1) a first private IP address assigned to the VPN client by an ISP server external to the wireless network and (2) a tentatively allocated private IP address assigned to the VPN client by a VPN server within the wireless network. In some embodiments, assigning mechanism 570 also allocates the aforementioned tentatively allocated private IP address. In some embodiments, the second private IP address is different from both the first private IP address and the tentatively allocated private IP address.

Detecting mechanism 580 generally detects an address conflict between two or more addresses allocated to a VPN client by multiple network server devices. Specifically, detecting mechanism 580 can extract the first private IP address from a message received from the VPN client. Detecting mechanism 580 can also compare the extracted first private IP address with a tentative private IP address allocated to the VPN client by assigning mechanism 570. Furthermore, detecting mechanism 580 determines whether the first private IP address is in conflict with the tentative private IP address. In some embodiments, the two private IP addresses are determined to be in conflict when they are identical to each other. In other embodiments, the two private IP addresses may be determined to be in conflict if they are within the same sub network or if they share the same subnet mask code.

Receiving mechanism 550, transmitting mechanism 560, assigning mechanism 570, and detecting mechanism 580 collectively operate with each other to accomplish VPN client IP address conflict detection. For example, assigning mechanism 570 may re-allocate the second private IP address corresponding to the VPN client in response to detecting mechanism 580 determines that the tentatively allocated private IP address is in conflict with the first private IP address assigned to the VPN client by the ISP server. As another example, transmitting mechanism 560 may transmit the single message to the VPN client in response to assigning mechanism 570 re-allocates the second private IP address corresponding to the VPN client.

According to embodiments of the present disclosure, network services provide by managed network device 500 include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a station (e.g., any data processing equipment such as a computer, cellular phone, personal digital assistant, tablet devices, etc.), an access point, data transfer devices (such as network switches, routers, controllers, etc.) or the like.

As used herein, an “interconnect” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “access point” (AP) generally refers to receiving points for any known or convenient wireless access technology which may later become known. Specifically, the term AP is not intended to be limited to IEEE 802.11-based APs. APs generally function to allow wireless devices to connect to a wired network via various communications standards.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. The description is this to be regarded as illustrative rather than limiting.

What is claimed is:

1. A method comprising:
receiving, at a network device in a wireless network, a message from a virtual private network (VPN) client, wherein the message comprises a first private Internet Protocol (IP) address corresponding to the VPN client; and
re-allocating, by the network device, a second private IP address corresponding to the VPN client, wherein the second private IP address resolves an IP address conflict between a tentatively allocated private IP address corresponding to the VPN client and the first private IP address.

2. The method of claim 1, further comprising:
allocating, by the network device, the tentative private IP address corresponding to the VPN client;
extracting, by the network device, the first private IP address from the received message; and
determining, by the network device, whether the tentative private IP address is in conflict with the first private IP address.

3. The method of claim 2, wherein re-allocating the second private IP address corresponding to the VPN client is performed in response to determining that the tentative private IP address is in conflict with the first private IP address.

4. The method of claim 1, wherein the second private IP address is different from the tentatively allocated IP address corresponding to the VPN client.

5. The method of claim 1, further comprising:
transmitting, by the network device, the second private IP address and the first private IP address to the VPN client in a single message in response to re-allocating the second private IP address.

6. The method of claim 5, wherein the second private IP address is included as an inner IP address in the single message, and wherein the first private IP address is include as an outer IP address in the single message.

7. The method of claim 1,
wherein the first private IP address is allocated by an ISP server external to the wireless network, and
wherein the tentatively allocated IP address and the second private IP address are both allocated by a VPN server within the wireless network.

8. A network device comprising:
a processor;
a memory;
a receiving mechanism coupled to the processor, the receiving mechanism to receive a message from a virtual private network (VPN) client, wherein the message comprises a first private Internet Protocol (IP) address corresponding to the VPN client; and
an assigning mechanism coupled to the processor, the assigning mechanism to re-allocating a second private IP address corresponding to the VPN client, wherein the second private IP address resolves an IP address conflict between a tentatively allocated private IP address corresponding to the VPN client and the first private IP address.

9. The network device of claim 8,
wherein the assigning mechanism further allocates the tentative private IP address corresponding to the VPN client; and
wherein the network device further comprises a detecting mechanism coupled to the process, the detecting mechanism to extract the first private IP address from the received message, and to determine whether the tentative private IP address is in conflict with the first private IP address.

10. The network device of claim 9, wherein the assigning mechanism re-allocates the second private IP address corresponding to the VPN client in response to the detecting mechanism determines that the tentative private IP address is in conflict with the first private IP address.

11. The network device of claim 8, wherein the second private IP address is different from the tentatively allocated IP address corresponding to the VPN client.

12. The network device of claim 8, further comprising a transmitting mechanism coupled to the processor, the transmitting mechanism to transmit the second private IP address and the first private IP address to the VPN client in a single message in response to re-allocating the second private IP address.

13. The network device of claim 12, wherein the second private IP address is included as an inner IP address in the single message, and wherein the first private IP address is include as an outer IP address in the single message.

14. The network device of claim 8,
wherein the first private IP address is allocated by an ISP server external to the wireless network, and
wherein the tentatively allocated IP address and the second private IP address are both allocated by a VPN server within the wireless network.

15. A non-transitory computer-readable storage medium storing embedded instructions that are executed by one or more mechanisms implemented within a network device to perform a plurality of operations comprising:
receiving a message from a virtual private network (VPN) client of a wireless network, wherein the message comprises a first private Internet Protocol (IP) address corresponding to the VPN client; and
re-allocating a second private IP address corresponding to the VPN client, wherein the second private IP address resolves an IP address conflict between a tentatively allocated private IP address corresponding to the VPN client and the first private IP address.

16. The non-transitory computer-readable storage medium of claim 15, wherein the plurality of operations further comprises:
allocating the tentative private IP address corresponding to the VPN client;
extracting the first private IP address from the received message; and
determining whether the tentative private IP address is in conflict with the first private IP address.

17. The non-transitory computer-readable storage medium of claim 16, wherein re-allocating the second private IP address corresponding to the VPN client is performed in response to determining that the tentative private IP address is in conflict with the first private IP address.

18. The non-transitory computer-readable storage medium of claim 15, wherein the second private IP address is different from the tentatively allocated IP address corresponding to the VPN client.

19. The non-transitory computer-readable storage medium of claim 15, wherein the plurality of operations further comprises:
transmitting the second private IP address and the first private IP address to the VPN client in a single message in response to re-allocating the second private IP address.

20. The non-transitory computer-readable storage medium of claim 19, wherein the second private IP address is included as an inner IP address in the single message, and wherein the first private IP address is include as an outer IP address in the single message.

21. The non-transitory computer-readable storage medium of claim 15,
wherein the first private IP address is allocated by an ISP server external to the wireless network, and
wherein the tentatively allocated IP address and the second private IP address are both allocated by a VPN server within the wireless network.
